(19) United States
(12) Patent Application Publication
(10) Pub. No.: US 2026/0029529 A1
(43) Pub. Date: Jan. 29, 2026

(54) LASER RANGEFINDER DEVICE

(71) Applicants: Mark Walker, Loomis, CA (US); Howard D. Kent, Waldport, OR (US)

(72) Inventors: Mark Walker, Loomis, CA (US); Howard D. Kent, Waldport, OR (US)

(21) Appl. No.: 18/781,836

(22) Filed: Jul. 23, 2024

(51) Int. Cl. G01S 17/08; G01S 7/481; G01S 7/51; G01S 17/86

(52) U.S. Cl. CPC G01S 17/08; G01S 7/4816; G01S 7/51; G01S 17/86

(57) ABSTRACT

A laser rangefinder device for determining the distance of an object includes an optical device for collecting an image, a laser associated with the optical device, and a laser beam having a constant angle of divergence. The laser beam is projectable onto the object to create a spot of light. The spot is included in the image. A scale element is carried by the optical device for determining a size of a dimension of the spot of light and using the size of the dimension to convert the spot of light to a distance to the object. A display device is carried by the optical device to display the collected image and the distance to the object.

### FIELD OF THE INVENTION

The present invention generally relates to range finding devices. More particularly, the present invention relates to laser range finding devices.

### BACKGROUND OF THE INVENTION

Methods and devices for determining the range (measuring the distance) of an object have been pursued throughout history. Knowing the distance to or between objects has great importance in many activities. In particular, knowing the distance to a target can greatly increase effectiveness whether it be in sports such as golf, and the like, or military usage for delivering munitions and increasing the accuracy of fired projectiles.

Many methods and devices have been developed over time. Modern range finding devices employ different technology to determine range. These include optical rangefinders, typically classified as coincidence and stereoscopic, and laser rangefinders. Optical rangefinders have been known for a long time and have changed little, while laser rangefinders have been known for a much shorter period of time. Optical rangefinders employ lenses and prisms to determine distance using parallax and are often used in cameras and surveying equipment. Laser rangefinders were developed after the creation of lasers. The development of lasers revolutionized the field of distance measurement and will be the focus here.

In operation, a laser rangefinder includes a laser that emits a laser beam. The beam hits a surface at which it is being aimed and reflects back toward the laser rangefinder. A receiver sensor carried by the laser rangefinder detects the reflected beam and, in combination with a high-speed clock, determines the time of flight of the reflected beam. Since the speed of the beam is known, the time interval of the reflected beam can be used to determine the distance to the object reflecting the beam. To increase accuracy, multiple pulses are employed to obtain averages to prevent errors. Current laser rangefinder devices can be complicated due to the very short time of flight (since the beam is traveling at the speed of light). Since the interval is so short, very high-speed clocks and extremely accurate timing circuits are required. Due to the complications and precision required, these devices can be quite costly and complicated.

While laser rangefinders are effective for determining distances of objects and are commonly used in both civilian and military applications, there are other drawbacks to their use. Current laser rangefinders emit continuous pulses of laser beams to enable accurate range determination. While these laser pulses are often produced in wavelengths invisible to the human eye, they can still be detected by various devices. The problem is that in military applications continuous or continuously pulsed beams can be detected by the enemy and reveal the user's position. It goes without saying that pinpointing an individual's location can be problematic in a conflict scenario.

### SUMMARY OF THE INVENTION

Briefly to achieve the desired objects and advantages of the instant invention in accordance with a preferred embodiment, provided is a laser rangefinder device for determining the distance of an object. The laser rangefinder device includes an optical device for collecting an image, a laser associated with the optical device, and a laser beam, having a constant angle of divergence, projectable by the laser onto the object to create a spot of light on the object. The spot is included in the image collected by the optical device. A scale element is carried by the optical device for determining a size of a dimension of the spot of light and using the size of the dimension to convert the spot of light on the object in the collected image to a distance to the object. A display device is carried by the optical device to display the collected image and the distance to the object.

In a specific aspect the display device is an ocular lens and the scale element is a reticle carried by the ocular lens and aligned with the laser beam. The reticle includes indicia overlying the spot of light on the collected image, with the size of the dimension of the spot of light on the collected image corresponding to the indicia designating the distance to the object.

In another aspect, the optical device is a digital imager for collecting a digital image including an object, a laser associated with the digital imager, and a laser beam projectable by the laser onto the object creating a spot of light on the object which is included in the digital image collected by the digital imager. The laser beam has a constant angle of divergence. A scale element includes a plurality of pixels defining a size of a dimension of the spot of light. The size of the dimension is used to convert the spot of light on the object in the collected image to a distance to the object. A display device is carried by the digital imager to display the collected image and the distance to the object. The scale element further includes a processing element using the plurality of pixels to determine the size of the dimension of the spot of light on the digital image, giving a base length of an isosceles triangle, the isosceles triangle defined by the laser beams constant angle of divergence and the base length, and calculating the distance of the object by determining the height of the isosceles triangle.

A method is also provided including the steps of collecting an image with an optical device, projecting a laser beam from a laser having a constant angle of divergence and associated with the optical device, onto an object. The laser beam creates a spot of light on the object and the spot of light is included in the image collected by the optical device. The method further includes the steps of providing a scale element carried by the optical device, using the scale element to determine a size of a dimension of the spot of light, and converting the spot of light on the object in the collected image to a distance to the object using the size of the dimension, and displaying the collected image and the distance to the object on a display device.

In a specific aspect, the step of providing the scale element includes providing a reticle carried by the ocular lens and aligned with the laser beam, the reticle including a plurality of indicia overlying the spot of light on the collected image. The step of converting the spot of light on the object in the collected image to a distance to the object includes matching the size of the dimension of the spot of light to a corresponding size of one of the indicia designating the distance to the object.

In a further aspect of the method, the step of collecting an image with the optical device includes providing a digital imager for collecting the image including the object and the spot of light as a digital image. The step of providing a scale element carried by the optical device includes the scale element being a plurality of pixels defining a dimension of the spot of light on the digital image. The step of converting the spot of light on the object in the collected image to a distance to the object includes using the plurality of pixels to determine the size of the dimension of the spot of light on the digital image, giving a base length of an isosceles triangle, the isosceles triangle defined by the laser beams constant angle of divergence and the base length, and calculating the distance of the object by determining the height of the isosceles triangle.

### BRIEF DESCRIPTION OF THE DRAWINGS

Specific objects and advantages of the invention will become readily apparent to those skilled in the art from the following detailed description of illustrative embodiments thereof, taken in conjunction with the drawings in which:

FIG. 1 is a schematic diagram of a laser rangefinder device according to the present invention;

FIG. 2 is a schematic view of an optical device with associated reticle of the rangefinder device illustrated in FIG. 1;

FIG. 3A is a diagram illustrating the reticle indicating a representative range for the laser rangefinder device illustrated in FIG. 1;

FIG. 3B is a diagram illustrating the reticle indicating another representative range for the laser rangefinder device illustrated in FIG. 1;

FIG. 3C is a diagram illustrating the reticle indicating a further representative range for the laser rangefinder device illustrated in FIG. 1;

FIG. 3D is a diagram illustrating the reticle indicating yet another representative range for the laser rangefinder device illustrated in FIG. 1;

FIG. 4 is a schematic diagram of a laser rangefinder device according to the present invention;

FIG. 5 is a schematic view of an optical device with associated digital image of the rangefinder device illustrated in FIG. 4;

FIG. 6 is an enlarged portion of the digital image of FIG. 5, illustrating the scale element; and

FIG. 7 is a schematic representation of a laser beam forming an isosceles triangle according to the present invention.

### DETAILED DESCRIPTION

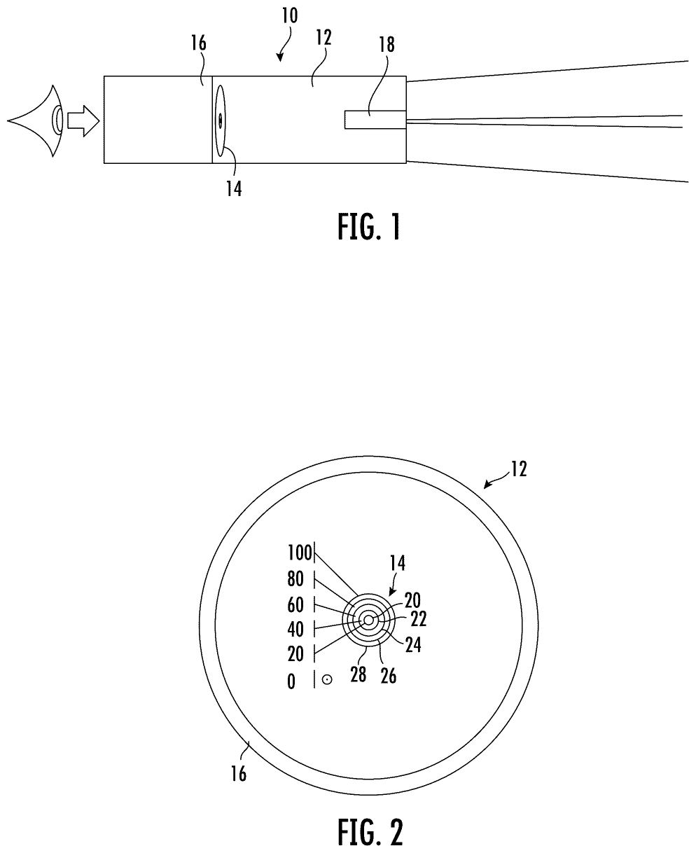

Turning now to the drawings, like reference characters indicating corresponding elements throughout the several views, attention is first directed to FIG. 1 which illustrates a laser rangefinder system, generally designated 10, according to the present invention. System 10 includes an optical device 12, such as a telescope, firearm scope, a digital camera (later described embodiment) and the like, a scale element 14, a display device 16, such as an ocular lens in the present embodiment or a monitor in a subsequent embodiment, and a laser 18. Laser 18 can be substantially any laser which projects a coherent beam of light (laser beam). In this preferred embodiment, the coherent beam of light has a visible wavelength for purposes which will be described presently. Additionally, the laser beam has a divergent angle which can be measured and is constant. Thus, as the light beam contacts an object, the “spot” formed is small at short distances and increases in size (due to divergence of the beam) as the distance to the contacted object increases. Preferably semiconductor lasers such as edge emitting lasers and vertical cavity surface emitting laser (VCSEL) are used. Laser 18 is coaxially mounted within optical device 12 as illustrated and aligned with scale element 14.

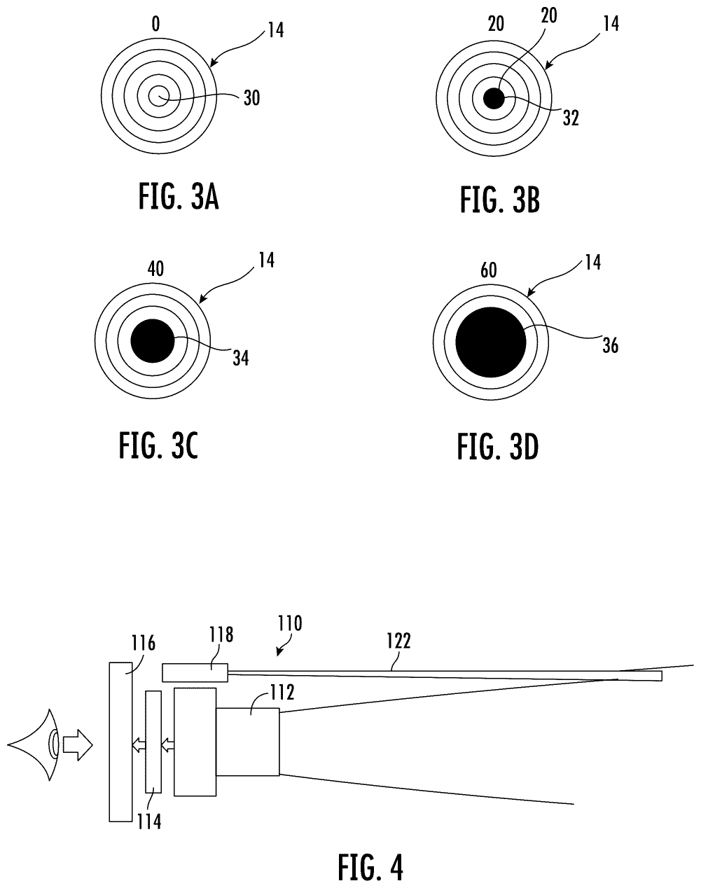

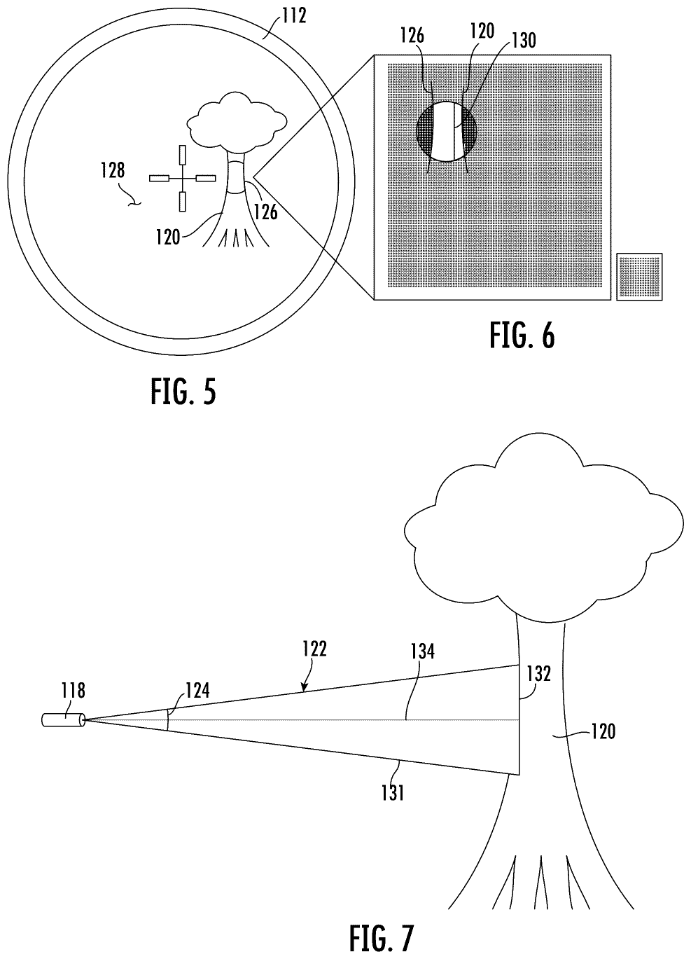

In this preferred embodiment, scale element 14 is a reticle associated with the ocular lens (display device 16). The reticle can be inscribed, printed, embedded, and the like, on the ocular lens. With additional reference to FIGS. 2 and 3A-3D, the reticle includes indicia such as a series of concentric rings 20, 22, 24, 26, and 28. It will be understood that while five concentric rings are employed in this embodiment, more rings or less rings can be used as desired. FIG. 2 illustrates the position of scale element 14 (the reticle) within optical device 12 associated with display device 16 (the ocular lens). Scale element 14 is centrally positioned and aligned with laser 18. Each of concentric rings 20, 22, 24, 26, and 28 indicate a predetermined distance associated with the divergence angle of the laser used and can be marked with the range. With specific reference to FIGS. 3A-3D, as laser 18 is used, a visible spot is projected on an object at a distance. The object and the spot of light form an image collected by the optical device and delivered to the ocular lens for display to a user. The image viewed through the ocular lens includes the spot of light overlying the reticle. Visible light is employed in this embodiment to facilitate visibility of the spot on the reticle. FIG. 3A illustrates a very small point 30 in the very center of scale element 14. This indicates that the laser beam has not diverged much and the distance to the object is very small. FIG. 3B has a larger spot 32 which visibly fills the first of the concentric rings, ring 20. This indicates that the object is further away. The distance can be calibrated as desired, but in this specific example, matching the concentric ring 20 indicates a distance or range of 20 yards. In FIGS. 3A-3D, the spot progressively increases in size in FIGS. 3C and 3D, with spots 34 and 36 filling progressively larger concentric rings 22 and 24, indicating progressively more distant objects. Spot 34 in FIG. 3C fills ring 22 indicating a distance of 40 yards and spot 34 in FIG. 3D fills ring 24 indicating a distance of 60 yards.

This is a simple and inexpensive device for determining distance to an object. The divergent angle of the laser acts as an apex angle and forms the equal sides of an isosceles triangle. If the length of the base is known, the height of the triangle can be determined using the principles of geometry. Thus, the concentric rings each designate a length of the base of the triangle. When the spot corresponds to one of the concentric rings, the length of the base is known, and the pre-calculated height of the triangle is known and is therefore calibrated. In this case the height of the triangle equals the range of the object when units are applied. It will be understood that while rings are employed in the current embodiment, other indicia including shapes and marks can be used, such as dotted lines, hash marks partial arcs and the like. Additionally, while a laser generating a cone shaped beam is preferred to project the spot, other shapes of beams can also be employed such as lines, squares and the like, resulting different shaped spots projected on the object. Indicia used for the reticle would be tailored to allow matching of the spot with the appropriate indicia.

Thus, a simple range finder is provided using a laser to determine distance to an object. A spot is projected onto an object at an unknown distance. An image is collected by the optical device including the object and the spot. The image is delivered to the ocular lens with the spot aligned with the reticle. The spot overlies the reticle consisting of a plurality of indicia (e.g. concentric circles) indicating corresponding distances. The size of the spot in relation to the plurality of indicia indicates the distance to the object.

Turning now to FIG. 4, another embodiment of a laser rangefinder system, generally designated 110, is illustrated. System 110 includes an optical device 112, which in this embodiment is a digital imager such as a digital camera and the like for generating a digital image, a scale element 114 (FIG. 6), a display device 116, such as a monitor, and a laser 118. Laser 118 can be substantially any laser which projects a coherent beam of light (laser beam). In this preferred embodiment, the coherent beam of light can be of substantially any wavelength as long as it is used with a corresponding a digital imager sensitive to that wavelength. Specifically, visible, ultraviolet and infrared wavelengths are preferably employed. Additionally, the laser beam has a divergent angle which is known and is constant. Preferably semiconductor lasers such as edge emitting lasers and vertical cavity surface emitting lasers (VCSEL) are used, although others are possible.

In this embodiment, optical device 112 is a digital imager for collecting a digital image. The digital imager can be defined as any device which collects phenomena in the electromagnetic spectrum and then provides that information in a digital format to a processing or display device 116. The digital image is a finite set of digital values, called picture elements or pixels. The digital image contains a fixed number of rows and columns of pixels formed in a grid. Pixels are the smallest individual element in an image, holding quantized values that represent the detected light at any specific point. The preferred embodiment of the present invention employs a digital camera as optical device 112 to generate a digital image.

With additional reference to FIGS, 5, 6 and 7, in operation, laser 118 is directed at a distant object 120 (e.g. a tree), the range of which is desired to be known. In this example, a conical laser beam 122 having a known angle of divergence 124 is employed. Laser beam 122 employs light of a specific wavelength to project a spot 126 on object 120. Optical device 112 generates a digital image 128 including object 120 and projected spot 126. Scale element 114 in this embodiment, is the pixels in spot 126 on object 120. Instead of a reticle as in the previous embodiment, scale element 114 is the number of pixels defining a length of a dimension such as width or height of spot 126 on object 120. With specific reference to FIG. 6, in this example, the length of the height of spot 126 is determined by the number of pixels in column 130 representing spot 126. System 110 collects a digital image including spot 126 projected on object 120 using laser beam 122 having a known and constant angular divergence 124. This can occur with different objects at different ranges. With specific reference to FIG. 7, laser beam 122 diverges from laser 118 with a known divergence angle 124 forming two sides of an isosceles triangle 131 with a known apex angle (divergence angle 124). When the beam projects spot 126 on object 120, a base 132 of isosceles triangle 131 is established. The pixels can be calibrated to determine the number of pixels per unit of distance to establish the length of the dimension. In this manner, a dimension of spot 126 can be determined from the number of pixels in a row or column representing spot 126, thereby giving the length of base 132 of isosceles triangle 131. Once the length of base 132 is known, a height 134 of triangle 131 can be determined using the principles of geometry. In this case a height 134 of triangle 131 also equals the range of object 120 when units are applied. As will be understood, the wavelength of laser beam 122 can be substantially any wavelength that can be collected by optical device 112 and which can be delineated from the rest of digital image 128 so that the pixels can be counted.

Referring back to FIG. 4, a processor 140 is included in laser rangefinder device 110 to receive and process digital image 128. Digital image 128 can be transmitted to processor 140 in many ways, such as wired or wireless. Wireless systems can be used to accommodate Bluetooth® or other systems for remote viewing. Processing includes determining the number of pixels in a dimension of spot 126 to establish a length of base 132, and calculating the distance to object 120 by calculating the height of isosceles triangle 131 using the base length and the known apex angle. The processed digital image is then displayed on monitor 116 with the distance value added. In some instances, spot 126 may not be complete. In other words, laser beam 122 may project a partial spot on object 120 with the rest of laser beam 122 passing by. If this occurs, in the case of a conical laser beam 122 as long as a portion of the curve of spot 126 is provided, the rest of the circle can be calculated and a dimension such as a diameter can be determined. Additionally, while a laser generating a cone shaped beam is preferred to project the spot, other shapes of beams can also be employed such as lines, squares and the like, resulting different shaped spots projected on the object. Each still generates an isosceles triangle with a known apex angle (divergence angle) and a measured base using a pixel count of a dimension of the projected spot.

The present invention is described above with reference to illustrative embodiments. Those skilled in the art will recognize that changes and modifications may be made in the described embodiments without departing from the nature and scope of the present invention. Various changes and modifications to the embodiments herein chosen for purposes of illustration will readily occur to those skilled in the art. To the extent that such modifications and variations do not depart from the invention, they are intended to be included within the scope thereof.

1. A laser rangefinder device for determining the distance of an object, the laser rangefinder device comprising:
an optical device for collecting an image including an object;
a laser associated with the optical device;
a laser beam projectable by the laser onto the object creating a spot of light on the object which is included in the image collected by the optical device, the laser beam having a constant angle of divergence;
a scale element carried by the optical device for determining a size of a dimension of the spot of light and using the size of the dimension to convert the spot of light on the object in the collected image to a distance to the object; and
a display device carried by the optical device to display the collected image and the distance to the object.

2. The laser rangefinder device as claimed in claim 1 wherein the display device includes an ocular lens for receiving and displaying the collected image.

3. The laser rangefinder device as claimed in claim 2 wherein scale element is a reticle carried by the ocular lens and aligned with the laser beam.

4. The laser rangefinder device as claimed in claim 2 wherein the reticle includes indicia overlying the spot of light on the collected image, with the size of the dimension of the spot of light on the collected image corresponding to the indicia designating the distance to the object.

5. The laser rangefinder device as claimed in claim 4 wherein the laser is coaxially mounted on the optical device relative to the ocular lens.

6. The laser rangefinder device as claimed in claim 1 wherein the optical device includes a digital imager for collecting the image including the object and the spot of light as a digital image.

7. The laser rangefinder device as claimed in claim 6 wherein the scale element is a plurality of pixels defining a dimension of the spot of light on the digital image.

8. The laser rangefinder device as claimed in claim 7 wherein the scale element further includes a processing element using the plurality of pixels to determine the size of the dimension of the spot of light on the digital image, giving a base length of an isosceles triangle, the isosceles triangle defined by the laser beams constant angle of divergence and the base length, and calculating the distance of the object by determining the height of the isosceles triangle.

9. The laser rangefinder device as claimed in claim 8 wherein the display device includes a monitor for displaying the digital image and the calculated distance of the object.

10. A method of determining a range to an object comprising the steps of:
collecting an image with an optical device;
projecting a laser beam from a laser having a constant angle of divergence and associated with the optical device, the laser beam creating a spot of light on an object, the spot of light is included in the image collected by the optical device;
providing a scale element carried by the optical device;
using the scale element to determine a size of a dimension of the spot of light;
converting the spot of light on the object in the collected image to a distance to the object using the size of the dimension; and
displaying the collected image and the distance to the object on a display device.

11. The method as claimed in claim 10 wherein the step of collecting an image with the optical device includes providing an ocular lens for receiving and displaying the collected image.

12. The method as claimed in claim 11 wherein the step of providing the scale element includes providing a reticle carried by the ocular lens and aligned with the laser beam, the reticle including a plurality of indicia overlying the spot of light on the collected image.

13. The method as claimed in claim 12 wherein the step of converting the spot of light on the object in the collected image to a distance to the object includes matching the size of the dimension of the spot of light to a corresponding size of one of the indicia designating the distance to the object.

14. The method as claimed in claim 10 wherein the step of collecting an image with the optical device includes providing a digital imager for collecting the image including the object and the spot of light as a digital image.

15. The method as claimed in claim 14 wherein the step of providing a scale element carried by the optical device includes the scale element being a plurality of pixels defining a dimension of the spot of light on the digital image.

16. The method as claimed in claim 15 wherein the step of converting the spot of light on the object in the collected image to a distance to the object includes using the plurality of pixels to determine the size of the dimension of the spot of light on the digital image, giving a base length of an isosceles triangle, the isosceles triangle defined by the laser beams constant angle of divergence and the base length, and calculating the distance of the object by determining the height of the isosceles triangle.

17. A laser rangefinder device for determining the distance of an object, the laser rangefinder device comprising:
a digital imager for collecting a digital image including an object;
a laser associated with the digital imager;
a laser beam projectable by the laser onto the object creating a spot of light on the object which is included in the digital image collected by the digital imager, the laser beam having a constant angle of divergence;
a scale element including a plurality of pixels defining a size of a dimension of the spot of light and using the size of the dimension to convert the spot of light on the object in the collected image to a distance to the object; and
a display device carried by the digital imager to display the collected image and the distance to the object.

18. The laser rangefinder device as claimed in claim 17 wherein the scale element further includes a processing element using the plurality of pixels to determine the size of the dimension of the spot of light on the digital image, giving a base length of an isosceles triangle, the isosceles triangle defined by the laser beams constant angle of divergence and the base length, and calculating the distance of the object by determining the height of the isosceles triangle.

19. The laser rangefinder device as claimed in claim 18 wherein the display device includes a monitor for displaying the digital image and the calculated distance of the object.
